(19) United States
(12) Patent Application Publication
(10) Pub. No.: US 2017/0060717 A1
(43) Pub. Date: Mar. 2, 2017

(54) METHOD AND SYSTEM FOR MANAGING PERFORMANCE OF INSTRUMENTATION DEVICES

(71) Applicant: Wipro Limited, Bangalore (IN)

(72) Inventors: Dattaguru Basavapatna NANJUNDAIAH, Bangalore (IN); Har Amrit Pal Singh DHILLON, Gurgaon (IN); Dinesh Kumar PATHAK, Ghaziabad (IN); Atul KUMAR, Greater Noida (IN); Sudheer DALAVAYLA, Bangalore (IN)

(73) Assignee: Wipro Limited

(21) Appl. No.: 14/931,048

(22) Filed: Nov. 3, 2015

(30) Foreign Application Priority Data
Sep. 2, 2015 (IN) 4653/CHE/2015

(51) Int. Cl. G06F 11/30; G01D 18/00

(52) U.S. Cl. CPC G06F 11/3065; G01D 18/00; G06F 11/3006; G06F 11/3089

(57) ABSTRACT

The present disclosure relates to a method for managing performance of at least one instrumentation device deployed across one or more sites. The method comprises receiving instrument data from the at least one instrumentation device. The instrument data comprises data pertaining to performance of the at least one instrumentation device. The method further comprises validating the instrument data based on at least one of predefined range parameters, predefined error parameters, predefined policy parameters, and historical analysis parameters. The method further comprises determining at least one of calibration issues, maintenance issues, reliability of at least one of the instrumentation device, and quality of the instrument data based on validation of the instrument data and generating performance report based on the validation and the determination for managing the performance of the one or more instrumentation devices.

### FIELD OF THE DISCLOSURE

The present subject matter generally relates to performance management of an instrumentation device. More particularly, but not exclusively, the present disclosure disclose a system and a method for managing performance of at least one instrumentation devices deployed across one or more sites.

### BACKGROUND

Conventional systems manage performance of instrumentation devices deployed at site level by gathering and analyzing data from the instrumentation devices to obtain energy utilization. The instrumentation devices may include energy meters, controlling devices, temperature sensors, fuel sensors, occupancy sensors, Carbon-dioxide (CO2) sensors and humidity sensors.

The data from the instrumentation devices is gathered at predefined interval of time. Deviations in the gathered data are detected based on predefined thresholds and predefined rules. However, quality of performance determined by the conventional systems is directly affected by quality of the data gathered from the instrumentation devices. Sometimes, there may be deviation in the gathered data due to issues associated with the instrumentation devices. The issues may be at least one of device failure, communication failure, calibration errors, manufacturing defects, tampering, improper handling, degradation and out of range issue. As a result of the issues, some data may be missed or the quality of the data may not be as required. Lack of timely detection and rectification of the issues associated with the instrumentation devices may affect the performance of the instrumentation device. Also, quality of performance determined by using this gathered data would lead to inaccurate results.

### SUMMARY

Disclosed herein is method and system for managing performance of at least one instrumentation device deployed across one or more sites using a performance management unit. The performance management unit receives and validates the instrument data from the instrumentation device. Further, the performance management unit determines at least one of calibration issue, maintenance issue, reliability of the instrumentation device and quality of the instrument device based on the validation and thereafter generates performance report of the instrumentation devices.

In one embodiment, the present disclosure relates to a method for managing performance of at least one instrumentation device deployed across one or more sites. The method comprises receiving instrument data from the at least one instrumentation device. The instrument data comprises data pertaining to performance of the at least one instrumentation device. The method further comprises validating the instrument data based on at least one of predefined range parameters, predefined error parameters, predefined policy parameters, and historical analysis parameters, determining at least one of calibration issues, maintenance issues, reliability of the at least one instrumentation device, and quality of the instrument data based on validation of the instrument data and generating performance report based on the validation and the determination for managing the performance of the at least one instrumentation device.

In another embodiment, the present disclosure relates to a performance management unit for managing performance of at least one instrumentation device deployed across one or more sites. The performance management unit comprises a processor and a memory which is communicatively coupled to the processor. The memory stores processor-executable instructions, which, on execution, cause the processor to receive instrument data from the at least one instrumentation device, wherein the instrument data comprises data pertaining to performance of the at least one instrumentation device. The processor validates the instrument data based on at least one of predefined range parameters, predefined error parameters, predefined policy parameters, and historical analysis parameters. The processor determines at least one of calibration issues, maintenance issues, reliability of the at least one instrumentation device, and quality of the instrument data based on validation of the instrument data. The processor generates a performance report based on the validation and the determination for managing the performance of the at least one instrumentation devices.

In another embodiment, the present disclosure relates to a non-transitory computer readable medium including instructions stored thereon that when processed by at least one processor cause a device to perform operations which comprises receiving instrument data from the at least one instrumentation device and validating the instrument data based on at least one of predefined range parameters, predefined error parameters, predefined policy parameters, and historical analysis parameters. The instrument data comprises data pertaining to performance of the at least one instrumentation device. The operations further comprises determining at least one of calibration issues, maintenance issues, reliability of the at least one instrumentation device, and quality of the instrument data based on validation of the instrument data and generating a performance report based on the validation and the determination for managing the performance of the at least one instrumentation device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for managing performance of at least one instrumentation device deployed across one or more sites in accordance with some embodiments of the present disclosure;

FIG. 2 illustrates a detailed block diagram of an exemplary performance management unit with various data and modules for managing performance of at least one instrumentation device in accordance with some embodiments of the present disclosure;

FIG. 3 shows a flowchart illustrating a method for managing performance of at least one instrumentation device in accordance with some embodiments of the present disclosure; and

FIG. 4 is a block diagram of an exemplary computer system for implementing some embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to a faster and reliable method and a performance management unit for managing performance of at least one instrumentation devices deployed across one or more sites. The at least one instrumentation devices may be connected to one or more electric appliances and include at least one of sensors, meters and controlling devices. The performance management unit receives instrument data from the at least one instrumentation device by monitoring the performance of at least one instrumentation device over a predefined time period. Then, the instrument data is validated based on at least one of predefined range parameters, predefined error parameters, predefined policy parameters, and historical analysis parameters. Further, the performance management unit determines at least one of calibration issues, maintenance issues, reliability of the at least one of the instrumentation device, and quality of the instrument data based on validation of the instrument data. Depending upon the validation and the determination, the performance management unit generates a performance report which provides precise status of the instrumentation devices along with reasons and solutions for the status. The present disclosure provides possible deviation information for incorrect or improper instrument data of the at least instrumentation device in one or more sites which helps to identify actual fault in the instrumentation device and/or the site.

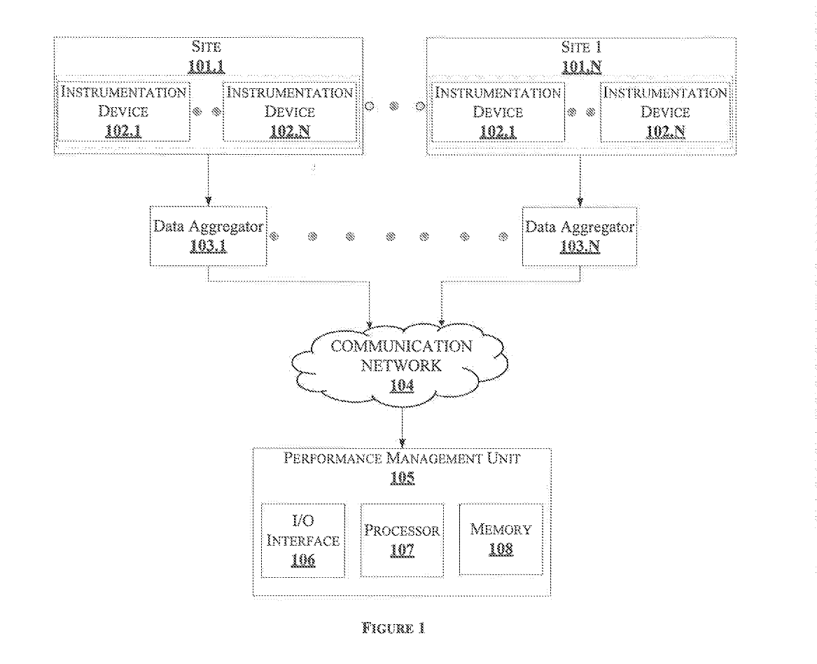

FIG. 1 illustrates an exemplary environment for managing performance of at least one instrumentation device deployed across one or more sites in accordance with some embodiments of the present disclosure.

The exemplary environment comprises of one or more sites 101.1 - - - 101.N (collectively referred as sites 101), at least one instrumentation devices 102.1 - - - 102.N (collectively referred as instrumentation devices 102) within each of the one or more sites 101, one or more data aggregators 103.1 - - - 103.N (collectively referred as data aggregators 103), communication network 104 and a performance management unit 105. The performance management unit 105 comprises of I/O interface 106, processor 107 and memory 108. In one implementation, the performance management unit 105 may be implemented in a variety of computing systems, such as a laptop computer, a desktop computer, a Personal Computer (PC), a notebook, a smartphone, a tablet, e-book readers (e.g., Kindles and Nooks), a server, a network server, and the like.

The instrumentation devices 102 are deployed across the sites 101. The instrumentation devices 102 may include, but are not limited to, sensors, meters and controlling devices. The instrument data from the instrumentation devices 102 of the sites 101 is obtained via the data aggregators 103 by monitoring the performance of the instrumentation devices 102 over a predefined time period. In one exemplary embodiment, the predefined time period is 2 minutes and the instrument data is received every 2 minutes. Every site 101 is associated with a data aggregator 103 which collects the instrument data from the instrumentation devices 102 of the respective site 101. The instrument data received by the data aggregator 103 may include, but is not limited to, energy data, temperature data, fuel data and other data associated with the instrumentation devices 102.

The performance management unit 105 receives the instrument data via the communication network 104 through I/O interface 106 of the performance management unit 105. Also, the I/O interface 106 provides results of the performance management unit 105 in a form of generated performance report. In one embodiment, the result may be provided on a display unit (not shown in Figure). Further, the I/O interface 106 is coupled with the processor 107 of the performance management unit 105.

In one embodiment, the instrument data received by the performance management unit 105 are in a form of data packets. In one embodiment, the communication network 104 is configured to be in listening mode and accept the data packets. In a non-limiting embodiment, the performance unit 105 decodes the received data packets as one of General Packet Radio Service (GPRS) packets, Open Building Information Exchange (OBiX) files, File Transfer Protocol (FTP) files and others associated with the data packets.

The memory 108 in the performance management unit 105 is communicatively coupled to the processor 107. The memory 108 stores processor executable instructions which on execution help the performance management unit 105 to manage the performance of the instrumentation devices 102. The processor 107 may comprise at least one data processor for executing program components for receiving instrument data from the instrumentation devices 102 where the instrument data comprises data pertaining to performance of the instrumentation devices 102. Further, the processor 107 is configured to validate the instrument data based on at least one of predefined range parameters, predefined error parameters, predefined policy parameters, and historical analysis parameters. Further, the processor determines at least one of calibration issues, maintenance issues, reliability of the at least one instrumentation device, and quality of the instrument data based on validation of the instrument data. Then, the processor 107 generates a performance report based on the validation and the determination for managing the performance of the instrumentation devices 102.

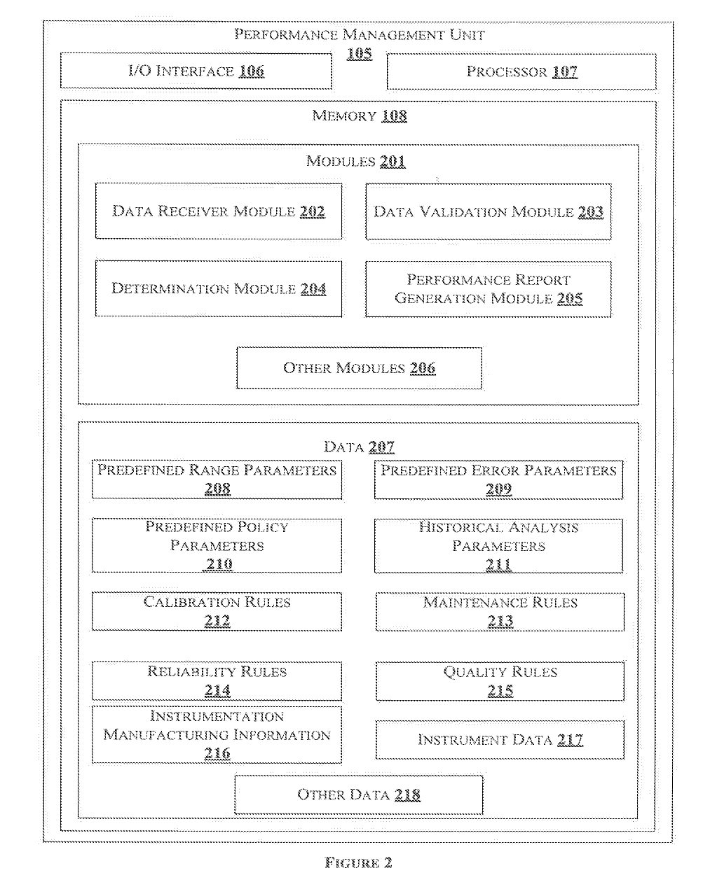

FIG. 2 illustrates a detailed block diagram of an exemplary performance management unit with various data and modules for managing performance of at least one instrumentation device in accordance with some embodiments of the present disclosure. In the illustrated FIG. 2, the one or more data 207 and the one or more modules 201 stored in the memory 108 are described herein in detail.

In an embodiment, the one or more data in the memory 108 are processed by the one or more modules 201 of the performance management unit 105. The one or more modules 201 may be stored within the memory 108 as shown in FIG. 2. In an example, the one or more modules 201, communicatively coupled to the processor 107, may also be present outside the memory 108 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one implementation, the one or more modules 201 may include, for example, a data receiver module 202, a data validation module 203, a determination module 204, a performance report generation module 205 and other modules 206 associated with the performance management unit 105.

The data receiver module 202 receives the instrument data from the at least one instrumentation device 102 via the I/O interface 106 of the performance management unit 105. For example, the temperature data is received from a temperature sensor which is monitored by the performance management unit 105 to manage the performance of the temperature sensor.

The data validation module 203 performs validation of the instrument data 217 of the instrumentation devices 102 based on at least one of predefined range parameters 208, predefined error parameters 209, predefined policy parameters 210, and historical analysis parameters 211 with respect to instrumentation manufacturing information 216 of that instrumentation device 102.

The determination module 204 determines at least one of calibration issues, maintenance issues, reliability of the at least one instrumentation device, and quality of the instrument data 217 based on validation of the instrument data 217. The determination is performed with respect to set of rules configured in a rule engine associated with the performance management unit 105. The set of rules includes the calibration rules 212, the maintenance rules 213, the reliability rules 214 and the quality rules 215 stored in the memory 108 of the performance management unit 105.

The performance report generation module 205 generates the performance report based on the validation and the determination for managing the performance of the instrumentation devices 102. The performance report comprises status of the instrumentation devices 102, reasons for the status and the solutions for the status. In an embodiment, the performance report is displayed by a display unit. The display unit to provide a user interface for managing the performance. Selection of the instrumentation data, selection of interested parameters of the instrumentation data and other information with respect to the instrumentation device may be obtained using the display unit. The status of the instrumentation device returns results of the data validation module 203 and determination module 204. Further, the reasons and the solutions for the status provide information regarding the issues in the instrumentation devices 102 and corresponding solutions for the issues. The performance report provides a proactive maintenance of the instrumentation devices 102, site level rectification and trigger data management. In an embodiment, the performance report includes alerting when anomalies detected during the validation and the determination performed by the performance management unit 105.

The other modules 206 may refer to such modules which can be referred for managing the performance of the instrumentation devices 102.

Further, the module 201 comprises of a learning module (not shown in Figure) which is configured to extract data from the system and further the data is used for updating the data 207 by implementing a learning mechanism. Also, the module 201 comprises web based intuitive module (not shown in Figure) which helps user to easily identify anomalies with respect to the instrumentation devices 102. Further, the intuitive model may provide alerts/alarms in the form of SMSs or emails when the anomalies are detected.

In one embodiment, the one or more data 207 may include, for example, predefined range parameters 208, predefined error parameters 209, predefined policy parameters 210, historical analysis parameters 211, calibration rules 212, maintenance rules 213, reliability rules 214, quality rules 215, instrument manufacturing information 216, instrument data 217 and other data 218 for managing the performance of the instrumentation devices 102. In one embodiment, the instrument data 217 is received in real-time for the validation and further used for the determination performed by the performance management unit 105. In an embodiment, the predefined range parameters 208, predefined error parameters 209, predefined policy parameters 210, historical analysis parameters 211, calibration rules 212, maintenance rules 213, reliability rules 214, quality rules 215 and instrument manufacturing information 216 of the data 207 are defined beforehand and stored in the performance management device 105.

The predefined range parameters 208 refer to predefined range of the instrumentation devices 102 which include, but are limited to, maximum and minimum values and limiting parameters of the instrument data 217. In one embodiment, the predefined range parameters 208 are defined by manufacturer of the instrumentation devices 102. During the validation performed by the performance management unit 105 based on the predefined range parameters 208, the instrument data 217 is compared with the predefined range parameters 208 and result is provided by the data validation module 203. The results may include one of the instrument data 217 in range and instrument data 217 not in range. For example, the temperature data obtained from the instrumentation device 102 which may be a temperature sensor is compared with predefined maximum and minimum values of the temperature sensor and result is provided by the data validation module 203 upon the comparison. Consider another example where the energy data at a load is compared with the limiting parameters of the load and the result after the comparison is provided by the data validation module 203.

The predefined error parameters 209 refer to error codes of the instrument data 217 of the instrumentation device 102. In the validation performed by the performance management unit 105 based on the predefined range parameters 209, the instrument data 217 is compared with the error codes and upon the comparison, related issues which include but limited to communication issue and connection issue is determined.

The predefined policy parameters 210 comprise predefined values of the instrument data 217 associated with the instrumentation device 102. In validation performed by the performance management unit 105 based on the predefined policy parameters 210, the instrument data 217 is compared with the predefined values and deviations of the instrument data 217 is determined. For example, temperature data from the instrumentation device 102 which may be a temperature sensor is compared with predefined value associated with the temperature sensor and deviation of the temperature data is determined by the data validation module 203.

The historical analysis parameters 211 refer to least one of error values and out of range values of the instrumentation devices 102 which are monitored for a longer predefined time range. In validation performed by the performance management unit 105 based on the historical analysis parameters 211, deviations and error values in the instrument data 217 for a predefined time range is determined. Upon the determination, the data validation module 203 provides the results which are used by the performance management unit 105 to perform further analysis of the validated data.

The calibration rules 212 are used for the determination of the calibration issues in the instrument data 217. Further to the results provided by the data validation module 203, the instrument data 217 is verified with the calibration rules 212 and determines one of presence and absence of the calibration issues in the instrumentation devices 102. For example, while installing an energy meter at a site, load of the energy meter is measured and ratio of current transformer is adjusted accordingly. Further, when the energy meter shows a wrong value, the performance management unit 105 receives the energy meter value and further the value is verified with the calibration rules 212 stored in the performance management unit 105 to determine the calibration issue. The value received is compared with the calibration rules 212 which comprises of predefined values of the energy meter. Further if the value is continuously maintaining the same ratio against the predefined values, the determination module 204 provides a result that there is no calibration issue. Further if the value is not continuously maintained against the predefined values, the determination module flags an issue and thereby the performance management unit 105 provides a result notifying a calibration issue.

The maintenance rules 213 are used for determining the maintenance of the instrument data 217. Further to the results provided by the data validation module 203, the instrument data 217 is verified with the maintenance rules 213 and determines one of presence and absence of the maintenance issues in the instrumentation devices 105. Further, if there is a presence of the maintenance issue, the determination module 204 provides reasons and solutions for the maintenance issue with the help of the data 207 in the performance management unit 105. For example, consider a lighting system whose lux level of lighting is regularly captured by the performance management unit 105 along with voltage levels for the lighting. Validation of the lux levels and the voltage levels from the lighting system is performed by the data validation module 203 based on the historical analysis parameters 211. Further, the rule engine runs at predefined regular intervals of time and determination of the maintenance issue is performed with respect to the maintenance rules 213. If for the same voltage level, lux level is degrading, the determination module 204 flags the maintenance issue and further the performance management unit 105 provides a result notifying a maintenance issue and alerts for a replacement of the lighting system.

The reliability rules 214 are used for the determination of reliability of the instrumentation device 102. The reliability is based on number of times of the occurrence of deviations in the instrument data 217 which include random deviations, missing of data and generation of errors in the instrument data with respect to the instrumentation manufacturing information 216 of that instrumentation device 102. For example, consider a temperature system from which temperature values are obtained through a temperature sensor. The temperature value is monitored by the performance management system 105 and further the validation and the determination is performed. Spikes in the temperature values is tracked regularly and if occurrence of the spikes in consistent, the performance management unit 105 determines that there is a maintenance issue associated with the temperature system. Further, if the occurrence of the spikes is not consistent, that is if the spikes occur without a defined pattern for a defined duration, the performance management unit 105 determines that there is a reliability issue associated with the temperature system.

The quality rules 215 are used for the determining quality of the instrument data 217. The quality is determined by performing consolidation of deviations detected during the validation of the instrument data 217.

The instrumentation manufacturing information 216 refers to details of the instrumentation devices 102. In an embodiment, the instrumentation devices 102 data may include manufacturing parameter details and model details of the instrumentation devices 102 which are set by manufacturers of the instrumentation device 102. The validation and the determination is performed by the performance management unit 105 for instrumentation device 102 with respect to the instrumentation manufacturing information 216.

The instrument data 217 refers to data obtained from the instrumentation device by monitoring the performance of the instrumentation device. The received instrument data received may include, but is not limited to, energy data, temperature data, fuel data and other data associated with at least one instrumentation device 102.

The other data 218 may refer to such data which can be referred for managing the performance of the instrumentation devices 102.

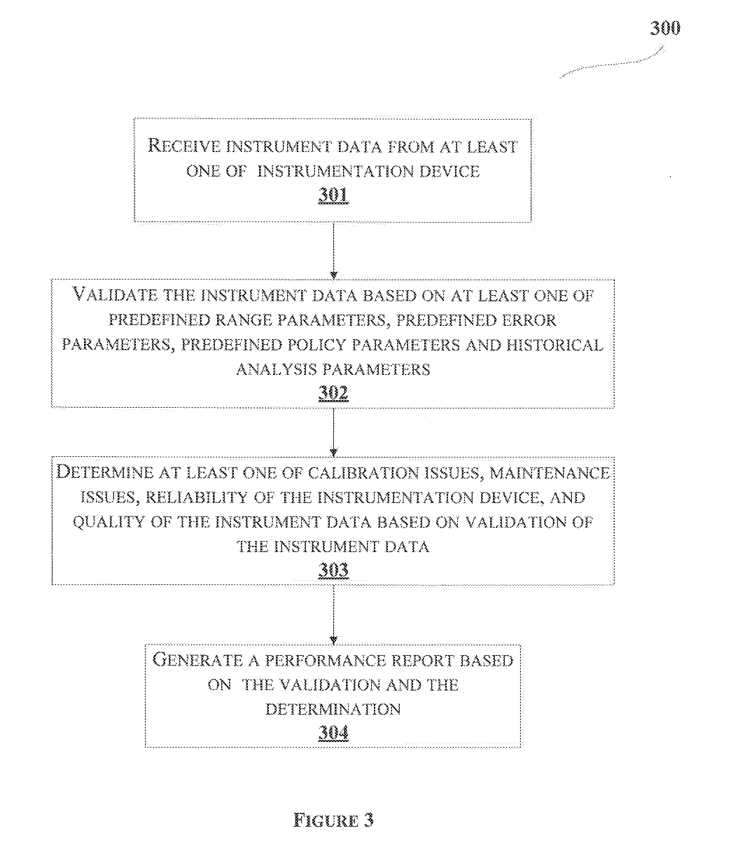

FIG. 3 shows a flowchart illustrating a method 300 for managing performance of at least one instrumentation device 102 in accordance with some embodiments of the present disclosure.

As illustrated in FIG. 3, the method comprises one or more blocks for managing performance of at least one instrumentation devices 102. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the performance management unit 105 receives the instrument data from at least one of instrumentation device 102. The instrument data 217 comprises data pertaining to performance of the instrumentation devices 102. In one embodiment, the instrument data 217 is obtained by monitoring the performance of the instrumentation devices 102 over a predefined time period.

At block 302, the performance management unit 105 validates the instrument data 217 based on at least one of predefined range parameters 208, predefined error parameters 209, predefined policy parameters 210, and historical analysis parameters 211. Validating the instrument data 217 based on the predefined range parameters 208 comprises determining the instrument data 217 to be in a predefined range of the instrumentation devices. In one embodiment, validating the instrument data 217 based on the predefined error parameters 209 comprises determining error in the instrument data 217. In one embodiment, validating the instrument data 217 based on the predefined policy parameters 210 comprises determining deviations in the instrument data 217 with respect to the predefined policy parameters 210. In one embodiment, validating the instrument data 217 based on the historical analysis parameters 211 comprises determining deviation in the instrument data 217 for a predefined time range.

At block 303, the performance management unit 105 based on the validation of the instrument data 217, determines at least one of the calibration issues 212, the maintenance issues 213, the reliability of the instrumentation devices 102, and the quality of the instrument data 217.

At block 304, the performance management unit 105 generates a performance report based on the validation and the determination for managing the performance of the instrumentation devices 102. In one embodiment, the performance report comprises at least one of status of the at least one instrumentation device 102, reasons for the status and solutions for the status.

### Computer System

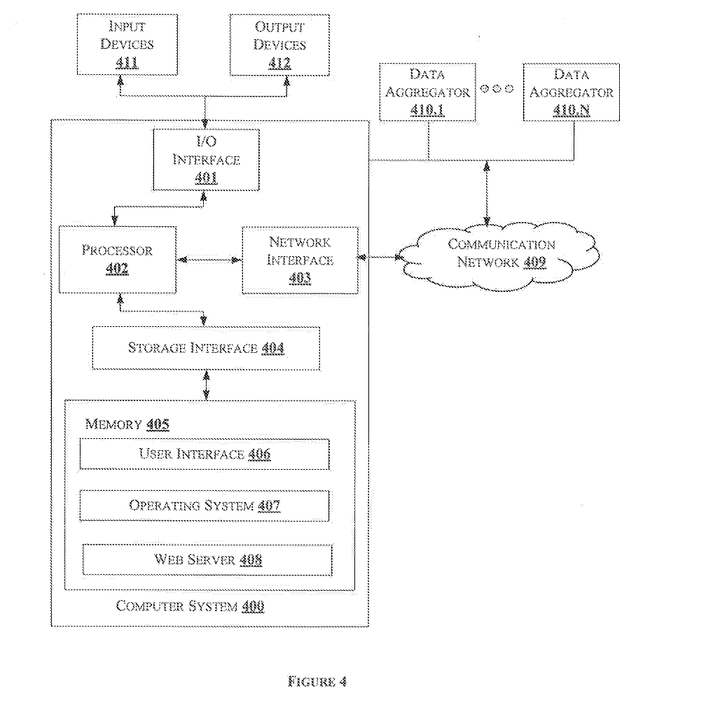

FIG. 4 is a block diagram of an exemplary computer system for implementing some embodiments consistent with the present disclosure.

In an embodiment, the computer system 400 is used to implement the performance management unit 102. The computer system 400 may comprise a central processing unit (“CPU” or “processor”) 402. The processor 402 may comprise at least one data processor for executing program components for managing the performance of at least one instrumentation device deployed across one or more sites. The processor 402 may include specialized processing units such as integrated system (bus) controllers, memory management control units, floating point units, graphics processing units, digital signal processing units, etc.

The processor 402 may be disposed in communication with one or more input/output (I/O) devices (not shown) via I/O interface 401. The I/O interface 401 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the computer system 400 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 400 is connected to the one or more data aggregator 410.1 - - - 410.N (collectively referred as data aggregators 410) through a communication network 409. The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. Using the network interface 403 and the communication network 409, the computer system 400 may communicate with the one or more data aggregator 410. The network interface 403 may employ connection protocols include, but not limited to, direct connect, Ethernet (e.g., twisted pair 10/100/1000 Base T), transmission control protocol/internet protocol (TCP/IP), token ring, IEEE 802.11 a/b/g/n/x, etc.

The communication network 409 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc. not shown in FIG. 4) via a storage interface 404. The storage interface 404 may connect to the memory 405 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, web server 408 etc. In some embodiments, computer system 400 may store user/application data (not shown in figure), such as the data, variables, records, etc. as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

In some embodiments, the computer system 400 may implement a web browser 408 stored program component. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Embodiments of the present disclosure are capable of monitoring instrumentation devices for managing the instrument device through time in light of precise measurements and benchmarks.

Embodiments of the present disclosure provide a faster and reliable system for managing the performance of the instrumentation device.

Embodiments of the present disclosure suggest a solution for an issue in the instrumentation device along with health status of at least one instrumentation device.

Embodiments of the present disclosure provide possible deviation information for incorrect or improper instrument data of the at least instrumentation device in one or more sites which helps to identify actual fault in the instrumentation device and/or the site.

Embodiments of the present disclosure obtain instrument data at close intervals of time to identify sudden jumps in the instrument data and report the issues which provide precise results of the performance generated.

Embodiments of the present disclosure provide historical communication information for the instrumentation device which is used to identify the issues of the instrumentation device at any instant of time.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 101.1 - - - 101.N | Site |
| 102.1 - - - 102.N | Instrumentation Device |
| 103.1 - - - 103.N | Data Aggregator |
| 104 | Communication Network |
| 105 | Performance Management Unit |
| 106 | I/O Interface |
| 107 | Processor |
| 108 | Memory |
| 201 | Modules |
| 202 | Data Receiver Module |
| 203 | Data Validation Module |
| 204 | Determination Module |
| 205 | Performance Report Generation Module |
| 206 | Other Modules |
| 207 | Data |
| 208 | Predefined Range Parameters |
| 209 | Predefined Error Parameters |
| 210 | Predefined Policy Parameters |
| 211 | Historical Analysis Parameters |
| 212 | Calibration Rules |
| 213 | Maintenance Rules |
| 214 | Reliability Rules |
| 215 | Quality Rules |
| 216 | Instrumentation manufacturing |
| | information |
| 217 | Instrument data |
| 218 | Other Data |
| 400 | Computer System |
| 401 | I/O Interface |
| 402 | Processor |
| 403 | Network Interface |
| 404 | Storage Interface |
| 405 | Memory |
| 406 | User Interface |
| 407 | Operating System |
| 408 | Web Server |
| 409 | Communication Network |
| 410.1 - - - 410.N | Data Aggregator |
| 411 | Input Devices |
| 412 | Output Devices |

What is claimed is:

1. A method for managing performance of at least one instrumentation device deployed across one or more sites, comprising:
receiving, by a performance management unit, instrument data from the at least one instrumentation device, wherein the instrument data comprises data pertaining to performance of the at least one instrumentation device;
validating, by the performance management unit, the instrument data based on at least one of predefined range parameters, predefined error parameters, predefined policy parameters, and historical analysis parameters;
determining, by the performance management unit, at least one of calibration issues, maintenance issues, reliability of the at least one instrumentation device, and quality of the instrument data based on validation of the instrument data; and
generating, by the performance management unit, a performance report based on the validation and the determination for managing the performance of the at least one instrumentation device.

2. The method as claimed in claim 1, wherein the instrument data is obtained by monitoring the performance of the at least one instrumentation device over a predefined time period.

3. The method as claimed in claim 1, wherein validating the instrument data based on the predefined range parameters comprises determining the instrument data to be in a predefined range of the at least one instrumentation device.

4. The method as claimed in claim 1, wherein validating the instrument data based on the predefined error parameters comprises determining error in the instrument data.

5. The method as claimed in claim 1, wherein validating the instrument data based on the predefined policy parameters comprises determining deviations in the instrument data with respect to the predefined policy parameters.

6. The method as claimed in claim 1, wherein validating the instrument data based on the historical analysis parameters comprises determining deviation in the instrument data for a predefined time range.

7. The method as claimed in claim 1, wherein the performance report comprises at least one of status of the at least one instrumentation device, reasons for the status and solutions for the status.

8. The method as claimed in claim 1, wherein the at least one instrumentation device include at least one of sensors, meters and controlling devices.

9. A performance management unit for managing performance of at least one instrumentation devices deployed across one or more sites, comprising:
a processor;
a memory communicatively coupled to the processor, wherein the memory stores processor-executable instructions, which, on execution, cause the processor to:
receive instrument data from the at least one instrumentation device, wherein the instrument data comprises data pertaining to performance of the at least one instrumentation device;
validate the instrument data based on at least one of predefined range parameters, predefined error parameters, predefined policy parameters, and historical analysis parameters;
determine at least one of calibration issues, maintenance issues, reliability of the at least one instrumentation device, and quality of the instrument data based on validation of the instrument data; and
generate a performance report based on the validation and the determination for managing the performance of the at least one instrumentation device.

10. The performance management unit as claimed in claim 9, wherein the instrument data is obtained by monitoring the performance of the at least one instrumentation device over a predefined time period.

11. The performance management unit as claimed in claim 9, wherein validating the instrument data based on the predefined range parameters comprises determining the instrument data to be in a predefined range of the at least one of instrumentation device.

12. The performance management unit as claimed in claim 9, wherein validating the instrument data based on the predefined error parameters comprises determining error in the instrument data.

13. The performance management unit as claimed in claim 9, wherein validating the instrument data based on the predefined policy parameters comprises determining deviations in the instrument data with respect to the predefined policy parameters.

14. The performance management unit as claimed in claim 9, wherein validating the instrument data based on the historical analysis parameters comprises determining deviation in the instrument data for a predefined time range.

15. The performance management unit as claimed in claim 9, wherein the performance report comprises at least one of status of the at least one instrumentation device, reasons for the status and solutions for the status.

16. The performance management unit as claimed in claim 9, wherein the at least one instrumentation device include at least one of sensors, meters and controlling devices.

17. A non-transitory computer readable medium including instructions stored thereon that when processed by at least one processor cause a device to perform operations comprising:
receiving instrument data from at least one instrumentation device, wherein the instrument data comprises data pertaining to performance of the at least one instrumentation device;
validating the instrument data based on at least one of predefined range parameters, predefined error parameters, predefined policy parameters, and historical analysis parameters;
determining at least one of calibration issues, maintenance issues, reliability of the at least one instrumentation device, and quality of the instrument data based on validation of the instrument data; and
generating a performance report based on the validation and the determination for managing the performance of the at least one instrumentation devices.

18. The medium as claimed in claim 17, wherein the instrument data is obtained by monitoring the performance of the at least one instrumentation device over a predefined time period.

19. The medium as claimed in claim 17, wherein validating the instrument data based on the predefined range parameters comprises determining the instrument data to be in a predefined range of the at least one instrumentation device.

20. The medium as claimed in claim 17, wherein validating the instrument data based on the predefined error parameters comprises determining error in the instrument data.

21. The medium as claimed in claim 17, wherein validating the instrument data based on the predefined policy parameters comprises determining deviations in the instrument data with respect to the predefined policy parameters.

22. The medium as claimed in claim 17, wherein validating the instrument data based on the historical analysis parameters comprises determining deviation in the instrument data for a predefined time range.

23. The medium as claimed in claim 17, wherein the performance report comprises at least one of status of the at least one instrumentation devices, reasons for the status and solutions for the status.

24. The medium as claimed in claim 17, wherein the at least one of instrumentation device include at least one of sensors, meters and controlling devices.
